(19) United States
(12) Patent Application Publication
(10) Pub. No.: US 2002/0136905 A1
(43) Pub. Date: Sep. 26, 2002

(54) Low shading coefficient and low emissivity coatings and coated articles

(76) Inventors: Paul A. Medwick, Glenshaw, PA (US); Russell C. Criss, Pittsburgh, PA (US); Mehran Arbab, Allison Park, PA (US); James J. Finley, Pittsburgh, PA (US); Denvra Criss, Pittsburgh, PA (US)

Correspondence Address: Kenneth J. Stachel, Esq., PPG Industries, Inc., One PPG Place, Pittsburgh, PA, 15272, US

(21) Appl. No.: 09/945,892

(22) Filed: Sep. 4, 2001

Related U.S. Application Data
(63) Continuation-in-part of application No. 09/714,166, filed on Nov. 17, 2000.
(60) Provisional application No. 60/167,386, filed on Nov. 24, 1999.

(51) Int. Cl. B32B 9/00

(52) U.S. Cl. 428/432; 428/469; 428/702; 428/699

(57) ABSTRACT

The present invention is directed to a low emissivity, low shading coefficient, multi-layer coating and coated article having a luminous transmission of less than about 70 percent, a shading coefficient less than about 0.44 and a solar heat gain coefficient of less than about 0.38 and a ratio of luminous transmittance to solar heat gain coefficient of greater than about 1.85. The coated article, e.g. an IG unit, has a substrate with at least one antireflective layer deposited over the substrate. At least one infrared reflective layer is deposited over the antireflective layer and at least one primer layer is deposited over the infrared reflective layer. Optionally a second antireflective layer is deposited over the first primer layer and optionally a second infrared reflective layer is deposited over the second antireflective layer. Optionally a second primer layer is deposited over the second infrared reflective layer and optionally a third antireflective layer is deposited over the second primer layer, such that the coated article can have the aforementioned optical properties. Also an optional protective overcoat, e.g. an oxide or oxynitride of titanium or silicon, and/or solvent soluble organic film former may be deposited over the uppermost antireflective layer.

### CROSS-REFERENCE TO RELATED APPLICATION

This application is a continuation-in-part application of U.S. patent application Ser. No. 09/714,166 filed Nov. 17, 2000, entitled “LOW SHADING COEFFICIENT AND LOW EMISSIVITY COATINGS AND COATED ARTICLES” which application claimed the benefits of U.S. Provisional Application No. 60/167,386, filed Nov. 24, 1999, entitled “LOW SHADING COEFFICIENT AND LOW EMISSIVITY COATINGS AND COATED ARTICLES”, which is herein incorporated by reference.

### FIELD OF THE INVENTION

This invention relates generally to heat-reflective and solar-control glazing materials such as multilayered coatings and to articles, e.g. windows or insulating glass units, incorporating such coatings and, more particularly, to solar-control metal oxide-containing coatings which may form solar-control articles having intermediate levels of luminous (visible light) transmittance, relatively low shading coefficient, low solar heat gain coefficient, low (less than 0.2) emissivity, a high ratio of visible light transmittance to solar heat gain coefficient, and acceptable aesthetics.

### Discussion OF Technical Considerations

In the design of buildings, architects are sometimes asked to incorporate large amounts of windows into the building design to increase the feeling of openness and light and/or to achieve a particular exterior aesthetic. However, windows are a major source of energy transfer either into or out of a building's interior. Energy transfer across a window glazing comprises: (1) heat flow into or out of a building due to a difference between indoor and outdoor temperatures, and (2) energy transfer into a building due to solar energy transmitted and/or absorbed and subsequently re-radiated as heat by the window glazing. The type of glazing that is optimal for any climate depends upon what energy transfer mechanisms have the most impact on the heating and/or cooling costs of the building and the respective lengths of the cooling and heating seasons in that geographic location.

Energy transfer due to the indoor-outdoor temperature difference is further subdivided into three different transport mechanisms: (a) conduction through the glazing and its gas contents, (b) convection associated with the movement of gases (e.g. air) at all surfaces of the glazing, and (c) thermal radiation from the surfaces of the various glazing materials. In order to reduce energy transfer across window glazings, multi-pane insulating glass (IG) units have been developed. Such multi-pane IG units inhibit energy transfer via conduction and convection pathways by creating an insulating gas pocket. However, the instant invention is most germane to energy transfer caused by thermal radiation and direct solar heat gain. Hereinafter, we therefore direct our discussion of energy transfer mostly to thermal radiation and direct solar heat gain rather than that due to conduction or convection. Of course the latter two energy transfer pathways should always be considered in building glazing design.

Considering thermal radiation and direct solar heat gain, for instance in warm, solar-intense climates under daylight conditions, energy enters into the building through the window glazing via several energy mechanisms. These include: (1) long-wave thermal infrared (IR) energy (i.e. heat) radiated from hot exterior surfaces such as pavement and buildings, and (2) the shorter wavelength ultraviolet, visible, and near infrared (or “solar infrared”) radiation from the sun. The first is due to the fact that the daytime outdoor temperature is higher than the indoor temperature. The second is either directly transmitted through the window or is first absorbed by the window glazing materials and then partially re-radiated into the interior space of the building. It is relevant to note that nearly all of the incident solar energy at the earth's surface falls almost approximately equally within the visible and solar infrared portions of the spectrum with a much smaller portion falling in the ultraviolet. The heat load contribution from the solar ultraviolet is much less than the amount of energy in the visible and solar infrared.

In cold climates, interior heat is lost through the windows is particularly acute at night thereby increasing the energy costs required to maintain a desired interior temperature. This loss is because the indoor temperature is higher than the outdoor temperature. In the case of cold climates, the heat loss due to the indoor-outdoor temperature difference is partially offset by the desirable passive solar heating of the interior space during daylight hours.

Radiative energy loss from a surface is governed by the surface's emissivity. Emissivity relates to the propensity of the surface to radiate energy. For surfaces near room temperature, this radiated energy falls within the long-wavelength thermal infrared portion of the electromagnetic spectrum. High-emissivity surfaces are good thermal radiators; a blackbody is a perfect radiator and is defined as having an emissivity of unity (e=1). In comparison, uncoated clear float glass has an emissivity of about 0.84, which is only around 16 percent less than a black-body.

Radiative energy transfer across a window glazing can be inhibited by reducing the emissivity of one or more surfaces of the glass. This emissivity reduction can be realized by the use of so-called “low emissivity” or “low-E” coatings applied to the glass surface(s). Low emissivity coated glasses are attractive for architectural windows since they significantly enhance the thermal insulating properties of the window glazing. These low-E coatings typically comprise multilayer thin film optical stacks. The optical stacks are designed to have high reflectance in the long-wavelength thermal infrared thereby inhibiting heat transfer due to radiation across the glazing whilst retaining a high level of luminous transmittance and low luminous reflectance in the shorter-wavelength visible portion of the spectrum. In this manner the coated glass does not dramatically depart from the visual appearance of an uncoated pane of glass. Such coatings are typically referred to as “high-T/low-E” coatings. Over the past twenty years, the use of such spectrally-selective high-T/low-E coated glasses has achieved widespread marketplace acceptance particularly in cool climates. In these climates the heating seasons are long and the passive solar heating achieved through the use of such high luminous transmittance coatings assists in counteracting heat loss due to indoor-outdoor temperature differences. One main type of such high-T/low-E coatings comprise one or more infrared-reflective layers (typically noble metals such as silver) sandwiched between dielectric layers (typically metal oxides or certain metal nitrides). Examples of low emissivity coatings are found, for example, in U.S. Pat. Nos. 5,821,001; 5,028,759; 5,059,295; 4,948,677; 4,898,789; 4,898,790; and 4,806,220, which are herein incorporated by reference.

However, because conventional high-T/low-E windows generally transmit a relatively high percentage of visible light, and solar infrared (“near infrared”) radiation to a somewhat lesser degree, use of such coatings can result in increased heat load to a building's interior in the summer season, thus increasing cooling costs. Although this problem is important for all types of buildings (such as residential homes) in solar-intense climates, it is particularly acute for so-called “commercial” architecture; that is, buildings that house office space or other facilities primarily intended for the purposes of business and commerce like office towers, business parks, high-rise hotels, hospitals, stadiums, and tourist attractions. Conventional high-T/low-E coated glasses do impart some degree of heat load reduction in hot climates because the low-E coating reduces the thermal infrared load from hot exterior surfaces into the building's interior. However they do not shade the building's interior as effectively from directly transmitted and absorbed solar energy.

As a point of terminology, the ability of a window glazing to shade the interior space from transmitted and absorbed solar energy is characterized by a parameter known as the glazing's “shading coefficient” (hereinafter referred to as “SC”). The term “shading coefficient” is an accepted term in the field of architecture. It relates the heat gain obtained when an environment is exposed to solar radiation through a given area of opening or glazing to the heat gain obtained through the same area of ⅛ inch (3 mm) thick single-pane clear uncoated soda lime silicate glass under the same design conditions (ASHRAE Standard Calculation Method). The ⅛ inch thick clear glass glazing is assigned a shading coefficient of SC=1.00. A shading coefficient value below 1.00 indicates better heat rejection than single-pane clear glass. A value above 1.00 would be worse than the baseline clear single pane glazing. A related solar-performance parameter is known as the “solar heat” gain coefficient (SHGC) which is approximately equal to the shading coefficient multiplied by 0.86 (i.e. SHGC=0.86 SC).

Conventional silver-based high-T/low-E coated glasses, briefly described above, typically have SCs of greater than or equal to 0.44 and luminous (visible) light transmittance of greater than or equal to 70%. All of these values are referenced to a double-glazed IG unit installation having clear glass substrates of the appropriate thickness for residential and commercial use. With such SCs, conventional high-T/low-E coated glasses are less optimal for hot, solar-intense climates.

What is needed and desirable, for at least hot, solar-intense climates as an object of the present invention are coatings to give transparency articles like window glazings (1) low-emissivity to inhibit heat ingress from the hot exterior via thermal radiation and, (2) low transmittance and/or low absorbance of direct solar radiation through the glazing. Such a glazing should exhibit relatively low shading coefficient (and therefore relatively low solar heat gain coefficient) as is desired for solar-intense climates while maintaining acceptable visible light transmission through the glazing.

### SUMMARY OF THE INVENTION

The present invention is directed to a low emissivity, low shading coefficient (i.e. low solar heat gain coefficient), multi-layer coating and coated article. The coating provides a coated article of a visible light-transmitting (e.g. transparent or at least translucent) substrate with a surface comprising the coating of: at least one antireflective layer deposited over a substrate surface; and at least one infrared reflective layer deposited over the at least one antireflective layer, such that the coated article comprises a visible light transmittance of less than 70%, a shading coefficient of less than 0.44, a solar heat gain coefficient of less than about 0.38, and a ratio of luminous transmittance to solar heat gain coefficient (“LSG”) of greater than about 1.85 (performance values quoted for a double-glazed IG unit).

The multi-layer coating of the present invention is a lower-T/low-SC/low-E coating as opposed to a high-T/low-E type coating for transparencies. The “T” refers to luminous (visible) light transmittance and the “E” refers to emissivity. The lower-T is generally in the range of less than 70% and includes middle-T which is generally in the range of greater than about 40% to about 70%. The coating is comprised of several primary layers that may be comprised of one or more films. These primary layers can be a first antireflective layer, a first infrared reflective layer, an optional first primer layer, second antireflective layer, a second infrared reflective layer, an optional second primer layer, and a third antireflective layer. Optionally at least one protective overcoat can be present. These layers are arranged predominantly in the order stated one on top of the other over a substantial portion if not all of one or more surfaces of the substrate. Any portion of the surface of the substrate can be coated for instance all of the surface except, in some instances, the perimeter of the surface may not be coated. Suitably when at least one surface of the substrate is coated and experiences exposure to light while in use, increased benefits from the invention are realized. The aforementioned layers of the inventive coating are primary layers in that other films or layers can be between the layers themselves or the stacks of the layers as long as these secondary layers or films do not interfere with the functioning of the primary layers.

The thickness of the layers of the coating is such that the individual infrared reflective layers generally may be greater than that for high-T/low-E coatings. Increasing the thickness of the infrared reflective layer like silver layer(s) much beyond that for high T/low E coatings both increases the long-wavelength thermal infrared reflectivity and increases the shorter-wavelength solar infrared reflectivity. The latter contributes to lowering the shading coefficient, the former effect reduces emissivity. Also in regards to the spectral characteristics of the infrared reflective layers, like silver thin films, simply increasing the thickness of the silver layer or film will simultaneously tend to increase the coating's reflectance and decrease the coating's transmittance in the visible region of the electromagnetic spectrum. This is an aesthetic issue that may be addressed by properly engineering all layers of the coating in order to achieve the desired solar-control performance while retaining acceptable aesthetics. In some cases, such thicker silver layer(s) can produce coatings that acquire reflected colors having unacceptable red or pink or gold or orange components viewed either at normal incidence or at an oblique (grazing) angle. An acceptable aesthetic product should minimize any components of the color red in reflection at any angle and at an oblique angle of reflection should avoid or minimize the color red.

Also in the present invention the thickness of the individual antireflective layers adjacent to the infrared reflective layers may be adjusted or modified to compensate for conditions resulting from any such increased thickness of the infrared reflective layers. These conditions are any increased visible reflectance or decreased visible transmittance. Such modification of the physical (and therefore optical) thickness of the adjacent dielectric layers (antireflective layer) to anti-reflect the silver layer(s) in the visible and to adjust the transmitted and reflected color of the coated article is possible. Furthermore, the design of the coating should take into account the aesthetics of the coated article at oblique (i.e. non-normal) incidence as well. Although an improvement may be viewed at normal incidence, the reflected color viewed at oblique incidence may remain objectionable, or vice versa. However, the optical characteristics of real thin film dielectric materials impose constraints on the efficacy of such an anti-reflection approach.

The coated article of the present invention can have a visible light-transmitting (e.g. transparent or translucent) substrate usually with two major surfaces as in the form of a flat, contoured, or curved sheet with the aforementioned coating on at least one of the surfaces. Also an embodiment of the present invention is an insulated glass unit (hereinafter referred to as “IG-unit”). In the IG-unit at least two visible light-transmitting substrates are sealed together with a space or gap between them generally for transparent insulating materials usually of a gaseous nature. The IG-unit can have any surface of the substrates in the IG unit with the aforementioned coating but suitable surfaces are either or both of the interior surfaces of the IG-unit. Also the coating could be arranged on one or more polymeric films or foils that is placed in the gap in the IG-unit. When the coating is disposed on the surface of the transparent substrate in an IG-unit the coating can be on at least one of the surfaces but preferably is on one of the surfaces facing the gap. The substrates in the IG-unit can be clear or tinted or colored transparent or translucent glass or plastic. For instance the coating can be on one of the interior surfaces of a substrate in the IG-unit which is clear or colored or tinted and the other substrate without the coating can be tinted or colored glass or plastic rather than clear or untinted or uncolored. For residential architectural applications of the present invention the coated article for use in an IG unit can have an aesthetically pleasing color in transmission and reflection. Neutral or near-neutral aesthetics are suitable for such residential architectural applications. However, chromatic aesthetics, in either transmission or reflection, may also be acceptable for such applications particularly in cases where one may not achieve the desired level of solar control without a willingness to depart from strictly neutral aesthetics. For commercial architectural applications of the present invention the IG-unit with the coated article of the present invention may have some non-neutral coloration since for such applications more aesthetic flexibility is possible.

Another aspect of the present invention is the coated article that is heat treated for heat strengthening, tempering, or bending (commonly referred to as heat-treated or tempered glasses as opposed to annealed glasses). The coating on these articles are designed so that the solar-control, emissive, and aesthetic properties of the product are still acceptable after the heat-treatment. Furthermore, it is possible to design heat-treatable coated articles such as glass having solar-control and aesthetic properties that are very similar to or match the corresponding properties of the like annealed products after the heat-treatable product has been subjected to heat treatment. In the latter case, the coated glass would be a so-called “temperable match” to its annealed product having similar solar-control properties.

The present invention accounts for the interdependence of solar performance, emissivity, and normal/oblique aesthetics, and in view of the limitations of real thin film optical materials, meets the challenge of producing a low-emissivity, solar-control coating having acceptable aesthetics. Such an article with such a coating can maintain acceptable aesthetics for transparencies for commercial architecture, residential architecture, automotive, aerospace, or other such applications.

### BRIEF DESCRIPTION OF THE DRAWINGS

FIG. 1 is a cross-sectional view, not to scale, of a coating incorporating features of the invention; and

FIG. 2 is a cross-sectional view of an IG unit incorporating features of the invention.

### DESCRIPTION OF THE INVENTION

For purposes of the following discussion, the phrase “deposited over” means deposited above but not necessarily adjacent to. Additionally, directional terms such as “left”, “right”, “inner”, “outer”, “upper”, “lower”, etc., and similar terms shall relate to the invention as it is shown in the drawing figures. However, it is to be understood that the invention may assume various alternative orientations. Hence, such terms are not to be considered as limiting. Also, the terms “coating” or “coating stack” include one or more coating layers and/or coating films. The terms “coating layer” or “layer” include one or more coating films. Also patents and published patent documents listed in this disclosure are hereby incorporated by reference in total and specifically for that which the patents are noted as teaching. Additionally in the following discussion the numerical ranges or values for the percentage of materials and for the thickness of all of the individual layers and films and coatings are approximate and may vary slightly below the lower limit and above the upper limit or around the specifically stated number as though preceded by the word “about” for each. For the purposes of this invention the term “optical thickness” is defined as the refractive index (the real component thereof) of a material multiplied by the physical (or “geometric”) thickness of the material, where the refractive index is measured at 550 nanometers (“nm”)

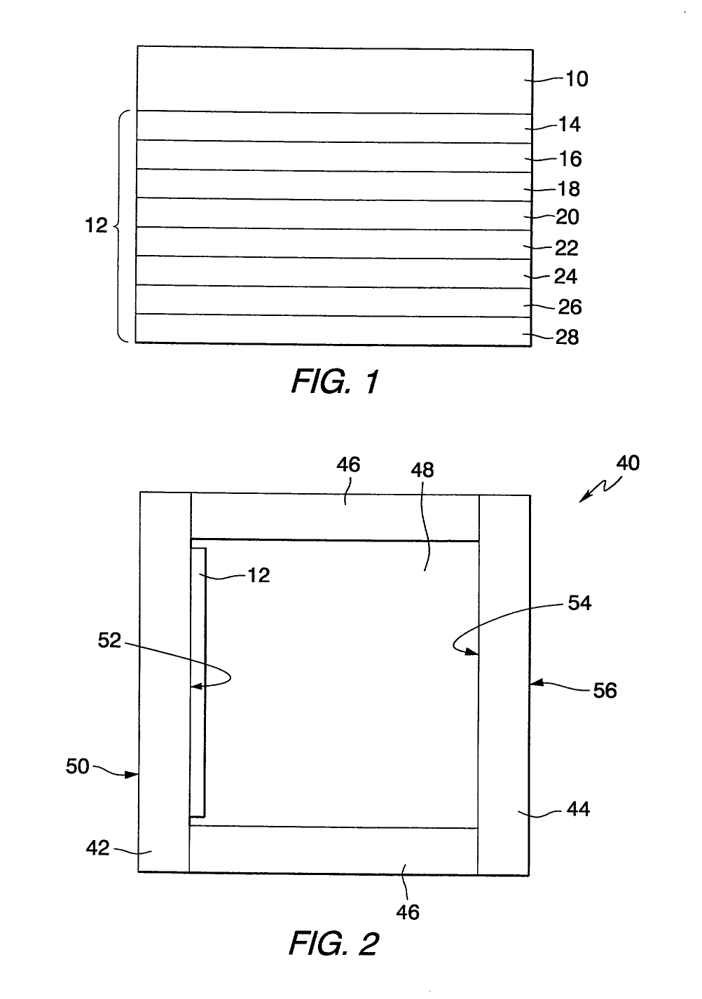

A substrate 10 having a low emissivity, low shading coefficient coating 12 incorporating features of the invention is generally shown in FIG. 1. The substrate 10 may be of any material but in the practice of the invention is preferably a visible light-transmitting (e.g. transparent substrate, such as glass, plastic or ceramic. However, tinted or colored substrates may also be used. In the following discussion, the substrate 10 is preferably glass. Examples of glass suitable for the practice of the invention are described, for example, in U.S. Pat. Nos. 4,746,347; 4,792,536; 5,240,886; 5,385,872; and 5,393,593.

The coating 12 is a multilayer coating and is deposited over at least a portion of the substrate surface in conventional manner. For example, the coating 12 may be applied by magnetic sputter vapor deposition (MSVD), chemical vapor deposition (CVD), spray pyrolysis, sol-gel, etc. In the currently preferred practice of the invention, the coating 12 is applied by MSVD. MSVD coating techniques are well known to one of ordinary skill in the glass coating art and hence will not be discussed in detail. Examples of MSVD coating methods are found, for example but not to be considered as limiting, in U.S. Pat. Nos. 5,028,759; 4,898,789; 4,948,677; 4,834,857; 4,898,790; and 4,806,220.

The coating 12 includes a base layer or first antireflective layer 14 deposited over at least a portion of one of the substrate surfaces. The first antireflective layer 14 preferably comprises one or more films of same or different dielectric materials or antireflective materials with similar refractive indices such as oxides of metal or metal alloys or nitrides or oxynitrides such as silicon nitride or silicon oxynitride or silicon alloys thereof, which are preferably transparent or substantially transparent. The nitrides and oxynitrides like those of silicon can include dopants that increase the conductivity for deposition. These dopants can include those like aluminum, nickel boron and the like known to those skilled in the art as in U.S. Pat. Nos. 6,274,244 and 5,552,180. Examples of suitable metal oxides include oxides of titanium, hafnium, zirconium, niobium, zinc, bismuth, lead, indium and tin and mixtures of any or all of these. These metal oxides may have small amounts of other materials, such as manganese in bismuth oxide, indium in tin oxide, etc. Additionally, oxides of metal alloys, such as zinc stannate or oxides of indium-tin alloys can be used. Further, doped metal oxides, such as antimony-, fluorine- or indium-doped tin oxides or mixture thereof can be used. The basecoat layer can have a first function to provide a nucleation layer for overlying layers subsequently deposited. Additionally or alternatively the function can be to allow some control over the aesthetics and solar-performance of the coated article. The relative proportions of films comprising the overall basecoat layer may be varied in order to optimize performance, aesthetics, and durability of the coated article. The first antireflective layer 14 preferably has a physical thickness in the range of 272 to 332 Angstroms, more preferably around 293 Angstroms. Alternatively or additionally the basecoat layer 14 can have an optical thickness of less than 900 Angstroms (“Å”). More preferably the optical thickness can be any value in the range of 350 to 830 Å like that in the range of 410 to 770 Å and most preferably in the range of 530 to 650 Å with the particularly preferred value of around 590 Å.

In the practice of the invention, the first antireflective layer 14 preferably comprises one or more oxides of zinc and tin. The first antireflective layer 14 may be a substantially single phase film such as zinc stannate or may be a mixture of phases composed of zinc and tin oxides or may be composed of a plurality of metal oxide films, such as those disclosed in U.S. Pat. No. 5,821,001. Preferably, the first antireflective layer 14 comprises one or more oxides of zinc and tin, e.g. zinc stannate. In a currently preferred embodiment of the invention, the first antireflective layer 14 is a multifilm structure as disclosed in U.S. Pat. No. 5,821,001 having a zinc stannate film deposited over the substrate surface and a zinc oxide film deposited over the zinc stannate film. The zinc stannate film is sputtered using a zinc-tin cathode which is 52 wt % zinc and 48 wt % tin. The zinc oxide film is deposited from a zinc cathode having 10 wt % or less of tin. The zinc oxide film has a preferred thickness of up to about 100 Angstroms in the layer as disclosed in U.S. Pat. No. 5,821,001. It is also possible that the zinc oxide film may be less than this thickness or may be omitted entirely thereby rendering the first antireflective layer 14 a single zinc stannate film.

Optionally, not shown in FIG. 1, a first sub-primer layer can be deposited over the basecoat dielectric layer 14. This sub-primer layer, which may comprise one or more films, may perform one or more functions similar to those of the basecoat layer. Alternatively or additionally the sub-primer may perform one or more of the following functions: (1) protecting an adjacent layer from damage and/or degradation during heat-treatment, if used on the coated article; and (2) enhance mechanical and/or chemical durability of the coated article's thin film layers. Suitable examples of materials for the sub-primer layer are generally the transition metals and alloys thereof such as: copper, titanium, nickel, Inconnel, stainless steel, tungsten, and alloys and mixtures of or with these. Generally the physical thickness of the sub-primer layer is less than 100 Å. The material and thickness of the sub-primer layer may also be designed to provide some light absorbance characteristics to the coated substrate, if desired.

A first IR reflective layer 16 is deposited over the first antireflective layer 14 or the sub-primer layer, if present. The first IR reflective layer 16 is preferably an IR reflective metal, such as gold, platinum, copper, silver, or alloys or mixtures of any or all of these that are IR reflective of solar and/or thermal IR. In addition the IR reflective layer 16 can exhibit some reflectivity in the visible light portion of the electromagnetic spectrum. Generally the physical thickness of the first IR reflective layer assists the layer in (1) providing rejection of solar-infrared radiation and/or visible light to help control solar heat gain through the use in transparencies, (2) when the first infrared-reflective layer exhibits appreciable reflectivity in the thermal infrared portion of the electromagnetic spectrum, to impart some low-emissivity characteristics to the coated article thereby inhibiting radiative heat transfer across/through a window structure; and (3) allowing some control over the aesthetics of the coated article. Optionally, any or all of the films comprising the first infrared-reflective layer may exhibit optical absorption in any region of the electromagnetic spectrum, if desired. In the preferred embodiment of the invention, the first IR reflective layer 16 comprises silver and preferably has a physical thickness in the range of 80 to 269 Angstroms, more preferably 86 Angstroms.

Optionally a first primer layer 18 which is preferably present as at least one film is deposited over the first IR reflective layer 16. The first primer layer 18 is a material deposited at such a thickness to minimize exposure of the IR reflective layer such as silver layer to degradative effects. One such effect is from a plasma environment used for deposition of subsequent, overlying films or layers. Such exposure can degrade the IR reflective layer via oxidation (in the case of an oxygen-containing plasma) or other plasma-induced damage. Another such effect could be from heat-treatment of the coated glass for those products that are designed and/or intended to be subjected to high-temperature processing after being coated. In addition, this first “barrier” or “primer” layer may contribute to and allow some control of the aesthetics and/or solar-control performance of the coated article. Optionally, any or all of the films comprising the first “barrier” or “primer” layer may exhibit optical absorption in any region of the electromagnetic spectrum.

Preferably the primer layer is at least one oxygen capturing film, such as titanium, that is sacrificial during the deposition process to prevent degradation of the first IR reflective layer 16 during the sputtering process. The first primer layer 18 preferably has a physical thickness of 8 to 30 Angstroms as disclosed in U.S. Pat. No. 5,821,001. For tempering of glass, the thickness of the primer layer can be increased and the thickness of the other layers can be altered to match or exceed the aesthetics and/or performance of the untempered glass. When the primer layer is not present, the IR reflective layer 16 should have a greater thickness to compensate for any of the aforementioned degradative effects.

A second antireflective layer 20 is deposited over the first primer film 18, when present, or over the thicker IR reflective layer 16. The second antireflective layer 20 preferably comprises one or more oxides of metal or metal alloy oxide films or nitrides or oxynitrides such as silicon nitride or silicon oxynitride, such as those described above with respect to the first antireflective layer 14. This layer can function: (1) to provide a nucleation layer for overlying layers subsequently deposited, and/or (2) to allow some control over the aesthetics and solar-control performance of the coated article. This second antireflective layer 14 is the dielectric layer between the first and second IR reflective layer 16 and is referred to as the centercoat layer. This centercoat layer comprises at least one film where more than one film can involve the same or different films with similar refractive indices in a similar fashion as described for the basecoat layer above. Optionally, any or all of the dielectric films comprising the dielectric “centercoat” layer may exhibit optical absorption in any region of the electromagnetic spectrum, if desired. It is also believed that the centercoat layer affords some protection of underlying layers from mechanical damage and/or chemical/environmental attack, degradation, or corrosion. The relative proportions of more than one film in the overall centercoat layer may be varied in order to optimize performance, aesthetics, and/or chemical/mechanical durability of the coated article.

In the currently preferred practice of the invention, the second antireflective layer 20 has a first film of zinc oxide deposited over the first primer film 18. A zinc stannate film is deposited over the first zinc oxide film and a second zinc oxide film is deposited over the zinc stannate film to form a multi-film antireflective layer. Each zinc oxide film of the second antireflective layer 20 is preferably up to about 100 Angstroms thick in physical thickness (see earlier comment), although the zinc oxide film may be less than this thickness. The second antireflective layer 20 preferably has a total physical thickness of less than 1300 Å and preferably a thickness of 698 to 865 Angstroms, more preferably 865 Angstroms. The optical thickness generally is less than 2600 Å preferably any value in the range of 1000 to 2450 Å, like 1350 to 2100 Å, and most preferably in the range of 1500 to 1900 Å.

Optionally a second “sub-primer” layer either present independently or in conjunction with the first sub-primer layer can be deposited over the centercoat dielectric layer, not shown is FIG. 1. Furthermore, said second “sub-primer” layer may comprise one or more films as with the first sub-primer layer and may fulfill one or more functions similar to the first sub-primer layer for the centercoat layer or the second IR reflective layer 20. Any or all of the films comprising the first “sub-primer” layer may be present in a thickness in a range similar to the range for the first sub-primer layer.

A second IR reflective layer 22 is deposited over the second antireflective layer 20. The second IR reflective layer 22 is preferably silver and most preferably a silver film although any of the materials listed for the first IR reflective layer 16 may be used. The physical thickness of this second IR reflective layer generally can be less than 238 Å more suitably any value in the range of 180 to 270 and preferably 200-290 Angstroms, more preferably 200 to 290 Angstroms. In the most preferred version of the present invention for an annealed glass product, the ratio of the physical thicknesses of the second silver-containing infrared-reflective layer to the first silver-containing infrared-reflective layer is in the range of 1.5-3.5, and even more preferably equal to about 2.0. Alternatively, the ratio of the real densities of metallic silver deposited (as determined by x-ray fluorescence spectroscopy) is in the range of about 1.5-3.5, and even more preferably equal to about 2.0.

An optional second primer layer 24 as the first primer layer is optional can be deposited over the second IR reflective layer 22. Any of the materials for the first primer layer can be used since the functions of the two layers are similar. Furthermore, any or all of the films comprising the second “barrier” or “primer” layer may exhibit optical absorption in any region of the electromagnetic spectrum, if desired. The second primer layer 24 is preferably titanium having a thickness of 8-30 Angstroms. Separately or in conjunction with the aforementioned preferred silver thickness ratios for the infrared-reflective layers, the embodiment of the present invention for annealed glass product has the first and second “barrier” or “primer” layers present as deposited titanium metal such that the amount of titanium deposited is about 0.25-2 μg/cm² (microgram per square centimeter). These primer layers are optional to the extent that if one or both are not present one or both IR reflective layers can have a thicker layer but not too thick as to adversely affect the optical properties of the coated glass.

A third antireflective layer 26 is deposited over the second primer layer 24. The third antireflective layer 26 is also preferably one or more metal oxides or metal alloy oxide containing films such as discussed above with respect to the first antireflective layer 14. Also the layer may be at least one film as in the centercoat layer. Generally the optical thickness of this third antireflective layer is less than 800 Å and more suitably any value in the range of 180 to 780 but preferably 210 to 730 Å. In practice, the third antireflective layer 26 includes a zinc oxide film up to about 100 preferably 20 to 70 Angstroms deposited over the second primer layer 24 as disclosed in U.S. Pat. No. 5,821,001. However the zinc oxide film may be less than this thickness or may be omitted entirely and a zinc stannate film can be deposited over this zinc oxide film. The third antireflective layer 26 has a total physical thickness of 60-273 Angstroms, preferably 115 Angstroms.

Optionally a protective overcoat 28 is deposited over the third antireflective layer 26 to provide protection against mechanical and chemical attack. The protective overcoat 28 is preferably an oxide of titanium like titanium dioxide having a physical thickness of 30-65 Angstroms. Alternatively or in addition thereto, a protective coating, such as one or more oxides or oxynitrides of silicon or one or more oxides of aluminum or mixtures or combinations of any of these, may be deposited over the titanium dioxide coating or in lieu thereof. Examples of suitable protective coatings are disclosed, for example, in U.S. patent application Ser. No. 09/058,440 and in U.S. Pat. Nos. 4,716,086; 4,786,563; 4,861,669; 4,938,857; and 4,920,006 and Canadian Application No. CA 2,156,571. In lieu of or in addition to the protective overcoat 28, temporary or removable protective films, layers or coatings can be used such as solvent soluble organic coatings like those described in U.S. patent application Ser. No. 09/567934, filed May 10, 2000, and similar to PCT application number WO US00/17326 filed Jun. 23, 2000. Some of these temporary protective coatings comprise: a water-soluble or water-dispersible film-forming, e.g., polymeric, material comprising one or more homopolymers or copolymers of starches, casein, and related polymers derived from proteins, acrylic polymers, polyacrylamide, polyalkylene oxide polymers such as ethylene oxide, polyvinyl acetate, polyvinyl alcohol, polyvinyl pyridine, styrene/acrylic acid copolymers, ethylene/acrylic acid copolymers, cellulosics and derivatives of cellulose such as, but not limited to, methyl cellulose, hydroxy propyl methyl cellulose, carboxymethylcellulose, ethylcellulose, alkyl hydroxyalkylcellulose, and derivatives, chemical modifications, combinations, blends, alloys and/or mixtures thereof. The polyvinyl alcohol preferably has a degree of hydrolyzation of greater than about 80%, preferably greater than about 85%. Suitable polyvinyl alcohol polymers for the practice of the invention are those formerly available from Air Products and Chemicals, Inc. of Allentown, Pa., as AIRVOL® 203, and 203S, polyvinyl alcohol powder or AIRVOL 24-203 aqueous polyvinyl alcohol solution (24 weight %) or dilutions thereof which are now commercially available from Celanese.

In obtaining a heat treated or tempered coated glass product that can be a close aesthetic match for the annealed coated glass product the coated article has a coating which may have thicker primer layers to protect the IR reflective layers. This coated glass is subjected to heat treatment (e.g. heat strengthening, tempering, bending) after having first removed any optional aforementioned Temporary Protective Overcoat layer present by contact of the article's coated surface with water.

FIG. 2 depicts an IG unit 40 incorporating features of the invention. The basic structure of an IG unit is described, for example, in U.S. Pat. No. 4,902,081. The IG unit 40 includes a pair of spaced-apart first and second transparent or semitransparent supports or substrates, such as first and second glass pieces 42 and 44, separated by one or more spacers 46. The glass pieces 42 and 44 and spacers 46 are sealed to form an interior gap or chamber 48 which may be filled with a selected atmosphere, such as argon or air. For purposes of the following discussion, the left glass piece 42 will be considered the exterior or outwardly facing side of the IG unit 40 and the right glass piece 44 will be considered the interior or inwardly facing side of the IG unit 40. The left glass piece 42 has an outer surface 50 and an inner surface 52. Similarly, the interior glass piece 44 has an outwardly facing or outer surface 54 and an inwardly facing or inner surface 56. The multi-layer coating 12 of the invention is preferably deposited either on the inner surface 52 of the exterior glass piece 42, as shown in FIG. 2, or the outer surface 54 of the interior glass piece 44. As discussed hereinbelow, the IG unit 40 having the coating 12 of the invention provides a visible light transmittance of less than 70% preferably any value between about 40% and 70%, a shading coefficient of less than 0.44; a solar heat gain coefficient of less than 0.38 and a ratio of luminous transmittance to solar heat gain of greater than about 1.85 preferably greater than 1.95. In an alternative embodiment the coated article can have an exterior reflectance of less than about 30% when normally positioned, e.g. the outer surfaces directed to the exterior of the structure and the inner surfaces directed to the interior of the structure.

### EXAMPLES

Coatings were prepared in accordance with the invention and analyzed for optical qualities. The coating layers were deposited at the specified thickness as shown in Table I on pieces of clear float glass of the thickness shown in Table I by MSVD for an IG unit. In the IG unit the coated glass was as reference number 44 and the coating as reference number 54 in FIG. 2. The structure of the coated samples is given in Table I, with the layer thickness given in Angstroms. In each sample, the first, second and third antireflective layers (AR layers) were multifilm zinc oxide and zinc stannate structures as described above. The numbers in Table I are for the total thickness of the specific layers, with each individual zinc oxide film in an AR layer being about 50 to 60 Angstroms thick. The first and second IR reflective layers (IR layers) were silver and the primer layers were titanium. The overcoat was titanium dioxide. The notation ND means that no data was taken.

For instance for example 14 and 15 the coated article was produced comprising a light-transmitting substrate of clear float glass. The coating on the float glass substrate had the below indicated layers where the physical thickness of the dielectric layers was measured by stylus profilometry and the amount of any layers deposited as metals (e.g. IR-reflective layers and primer layers) was measured by x-ray fluorescence spectroscopy. In Table I, we also list approximate estimated physical thicknesses of the metallic IR-reflecting silver layers and the metallic Ti primer layers by assuming that the mass density (in g/cm³) of the metallic layer as deposited is equal to the mass density of bulk silver and titanium, respectively, tabulated in any handbook or version of the Periodic Table of the Elements.

I. The first (“basecoat”) dielectric layer comprising: (1) a film of an oxide of an alloy of 54% zinc:46% tin (by weight), and (2) a film of an oxide of an alloy of 90% zinc:10% tin (by weight); and

II. Metallic silver (Ag) was the first infrared-reflective layer in an amount for example 14 of about 11.0 μg/cm² and for example 15 of 10.6 μg/cm²; and

III. metallic titanium (Ti) was the first “barrier” or “primer” layer deposited in an amount of about 0.56 μg/cm² and 1.05 μg/cm² for examples 14 and 15 respectively; and

IV. the second (“centercoat”) dielectric layer for both examples 14 and 15 was: (1) a film of an oxide of 90% zinc:10% tin alloy, and (2) a film of an oxide of an alloy of 54% zinc:46% tin, and (3) a film of an oxide of an alloy of 90% zinc:10% tin; with the physical thickness of the centercoat as indicated in Table I; and

V. the second infrared-reflective layer for both of these examples was metallic silver (Ag) in an amount deposited of about 25.1 μg/cm² at the physical thickness of Table I; and

VI. the second “barrier” or “primer” layer deposited for both examples was metallic titanium (Ti) in an amount of about 1.05 and 0.96 μg/cm² for examples 14 and 15 respectively at the thickness indicated in Table I; and

VII. the third dielectric layer as a (“topcoat”) or “upper coat” was: (1) a film of an oxide of an alloy of 90% zinc:10% tin, and (2) a film of an oxide of an alloy of 54% zinc:46% tin; for both examples with the physical thickness of each example indicated in Table I; and

VIII. the protective overcoat layer for both examples had an oxide of titanium (Ti) with the physical thickness shown in Table I.

The optical and performance characteristics of the samples of Table I are shown in Table II. The optical characteristics in Table II are calculated values (“center of glass”) for an IG unit incorporating the respective sample coatings. These calculations used measured spectral reflectance and transmittance data for each sample and the “WINDOW” 4.1 simulation software program available from Lawrence Berkeley National Laboratory. All of the optical characteristics in Table II, with the exception of LCS, are standard and well known terms in the glass industry. The term “LCS” refers to a light to cooling selectivity index and is defined as the percent visible light transmittance (expressed as a decimal) divided by the shading coefficient. The term “LHS” refers to light to heat selectivity ratio which is similar to “LSG” which stands for “light to heat gain” ratio. “LHS” and “LSG” are synonymous and equal to the glazing's percent visible light transmittance (expressed as a decimal) divided by the glazing's solar heat gain coefficient.

Table III and IIIB shows several listed physical parameters for monolithic glass samples each coated with the indicated coatings of Table I and also shows the listed performance data for these glasses.

TABLE I

| | Glass | | | | | | | | |
|---|---|---|---|---|---|---|---|---|---|
| Sam- | thick- | | | | | | | | |
| ple | ness | 1st | | | | | | 3rd | Over- |
| No. | inch | AR | Ag | Ti | 2nd AR | 2nd Ag | Ti | AR | coat |
| 1 | 0.1596 | 332 | 128 | 15 | 771 | 246 | 15 | 168 | 45 |
| 2 | 0.0862 | 312 | 236 | 15 | 698 | 159 | 15 | 202 | 45 |
| 3 | 0.0863 | 272 | 236 | 15 | 845 | 192 | 15 | 196 | 45 |
| 4 | 0.0863 | 313 | 246 | 15 | 863 | 210 | 15 | 250 | 45 |
| 5 | 0.126 | 300 | 86 | 13 | 714 | 175 | 13 | 123 | 30 |
| 6 | 0.126 | 300 | 86 | 13 | 714 | 175 | 13 | 60 | 30 |
| 7 | 0.125 | 300 | 95 | 13 | 734 | 184 | 13 | 98 | 30 |
| 8 | 0.126 | 300 | 103 | 13 | 808 | 202 | 13 | 194 | 30 |
| 9 | 0.126 | 300 | 107 | 13 | 734 | 167 | 13 | 98 | 30 |
| 10 | 0.126 | 300 | 103 | 13 | 714 | 184 | 13 | 98 | 30 |
| 11 | 0.124 | 293 | 80 | 17 | 719 | 178 | 16 | 105 | 43 |
| 12 | 0.123 | 293 | 86 | 17 | 695 | 178 | 16 | 105 | 43 |
| 13 | 0.125 | 293 | 86 | 17 | 719 | 178 | 16 | 115 | 43 |
| 14 | 0.126 | 295 | 105 | 12 | 865 | 239 | 23 | 182 | 61 |
| 15 | 0.126 | 295 | 101 | 23 | 865 | 239 | 21 | 141 | 61 |

TABLE II

| | | % ext | | | | | | | |
|---|---|---|---|---|---|---|---|---|---|
| | | vis | % int via | Summer | Solar heat | | | | |
| Sample | | reflect- | reflect- | shading | gain | | LHS or | | Winter |
| No. | % vis | ance | ance | coefficient | coefficient | LCS | LSG | Emissivity | U-value |
| 1 | 55.2 | 21.8 | 29.2 | 0.29 | 0.25 | 1.90 | 2.21 | 0.03 | 0.24 |
| 2 | 56.8 | 25.3 | 20.4 | 0.29 | 0.25 | 1.96 | 2.27 | 0.029 | 0.29 |
| 3 | 57.2 | 25.7 | 24.5 | 0.29 | 0.25 | 1.97 | 2.29 | 0.041 | 0.30 |
| 4 | 58.9 | 23.8 | 22.3 | 0.29 | 0.25 | 2.03 | 2.36 | 0.039 | 0.30 |
| 5 | 56.7 | 21.9 | 29.1 | 0.33 | 0.28 | 1.72 | 2.03 | 0.032 | 0.29 |
| 6 | 51.2 | 26.3 | 35.5 | 0.30 | 0.25 | 1.71 | 2.05 | 0.032 | 0.29 |
| 7 | 53.1 | 24.7 | 33 | 0.30 | 0.26 | 1.77 | 2.04 | 0.033 | 0.29 |
| 8 | 54.1 | 25.5 | 31.8 | 0.30 | 0.26 | 1.80 | 2.08 | 0.029 | 0.29 |
| 9 | 58.6 | 19.8 | 26.6 | 0.32 | 0.28 | 1.83 | 2.09 | 0.031 | 0.29 |
| 10 | 53.2 | 22.2 | 31.6 | 0.29 | 0.25 | 1.83 | 2.13 | 0.029 | 0.29 |
| 11 | 54.3 | 25.1 | 32.5 | 0.32 | 0.27 | 1.70 | 2.01 | 0.029 | 0.29 |
| 12 | 55.0 | 23.4 | 31.4 | 0.31 | 0.27 | 1.77 | 2.04 | 0.048 | 0.30 |
| 13 | 56.0 | 23.5 | 30.6 | 0.32 | 0.28 | 1.75 | 2.00 | 0.048 | 0.30 |
| 14 | 47.0 | 32.7 | 37.0 | 0.27 | 0.23 | 1.74 | 2.04 | 0.022 | 0.28 |
| 15 | 48.3 | 35.3 | 38.5 | 0.28 | 0.24 | 1.73 | 2.01 | 0.018 | 0.28 |

TABLE III
Monolithic Performance Data (all data are center-of-glass)

| | | | | | | | | summer | solar heat | | | |
|---|---|---|---|---|---|---|---|---|---|---|---|---|
| | | | | | | | | shading | gain | | | |
| | clear | | | coating- | | | | coefficient | coefficient | | | |
| | glass | visible | glass-side | side | | TSER- | | (energy | (energy | | | |
| | thick- | trans- | visible | visible | | glass- | TSER- | incident on | incident on | | | coated |
| Sample | ness | mittance | reflectance | reflectance | TSET | side | coating- | coated | coated | | | surface |
| ID | (inch) | (%) | (%) | (%) | (%) | (%) | side (%) | surface) | surface) | LCS | LHS | emissivity |
| 1 | 0.1596 | 60.3 | 18.6 | 25.3 | 28.2 | 37.9 | 60.7 | 0.38 | | | | 0.030 |
| 2 | 0.0862 | 62.1 | 21.9 | 14.2 | 25.3 | 51.3 | 59.2 | 0.35 | 0.30 | 1.77 | 2.07 | 0.029 |
| 3 | 0.0863 | 62.3 | 22.3 | 18.9 | 25.1 | 51.3 | 60.2 | 0.35 | 0.30 | 1.78 | 2.08 | 0.041 |
| 4 | 0.0863 | 64.2 | 20.2 | 16.4 | 24.8 | 51.7 | 60.7 | 0.34 | 0.30 | 1.89 | 2.14 | 0.039 |
| 5 | 0.126 | 61.8 | 18.6 | 25.0 | 27.5 | 40.0 | 61.5 | 0.36 | 0.31 | 1.72 | 1.99 | 0.032 |
| 6 | 0.126 | 55.4 | 23.5 | 32.5 | 24.6 | 42.3 | 65.4 | 0.32 | 0.28 | 1.73 | 1.98 | 0.032 |
| 7 | 0.125 | 57.6 | 21.8 | 29.6 | 24.7 | 42.7 | 65.0 | 0.33 | 0.28 | 1.75 | 2.06 | 0.033 |
| 8 | 0.126 | 58.8 | 22.5 | 28.1 | 25.1 | 42.4 | 61.1 | 0.33 | 0.29 | 1.78 | 2.03 | 0.029 |
| 9 | 0.126 | 64.0 | 16.2 | 21.9 | 27.1 | 40.6 | 61.6 | 0.36 | 0.31 | 1.78 | 2.06 | 0.031 |
| 10 | 0.126 | 57.8 | 19.2 | 27.9 | 23.8 | 43.4 | 65.8 | 0.32 | 0.27 | 1.81 | 2.14 | 0.029 |
| 11 | 0.124 | 58.9 | 22.0 | 29.0 | 26.8 | 40.9 | 62.8 | 0.35 | 0.30 | 1.68 | 1.96 | 0.029 |
| 12 | 0.123 | 59.7 | 20.3 | 27.7 | 26.4 | 41.4 | 63.2 | 0.35 | 0.30 | 1.71 | 1.99 | 0.048 |
| 13 | 0.125 | 60.9 | 20.3 | 26.8 | 27.2 | 40.9 | 62.3 | 0.35 | 0.31 | 1.74 | 1.96 | 0.048 |

TABLE IIIB
Monolithic Data for 3.2 mm Clear Glass Substrate with Solar-Control Coating

| | | | | Coated Surface | | | | | | | | | | |
|---|---|---|---|---|---|---|---|---|---|---|---|---|---|---|
| | Transmitted Color | | | Reflected Color | | | Glass Surface | | | Solar Performance | | | | |
| | Data⁵ | | | Data⁵ | | | Reflected Color Data⁵ | | | Data | | | | |
| Sample | | | | | | | | | | TSET | TSER1 | TSER2 | | Rₛₕₑₑₜ |
| ID | L* | a* | b | L* | a* | b | L* | a* | b* | (%)² | (%)² | (%)² | Emissivity¹ | (ohms/sq)⁶ |
| Ex. 14³ | 79.21 | −2.69 | −0.04 | 62.33 | −1.83 | 14.33 | 59.30 | −10.36 | 0.24 | 25.8 | 63.7 | 42.8 | 0.025 | 1.14 |
| (3.2 | | | | | | | | | | | | | | |
| mm) | | | | | | | | | | | | | | |
| Ex. 14⁴ | 77.14 | −3.34 | 0.04 | 65.52 | −1.95 | 12.83 | 62.35 | −10.88 | −0.52 | 24.80 | 63.87 | 37.06 | 0.022 | no data |
| (6 mm) | | | | | | | | | | | | | | |
| Ex. 15³ | 78.90 | −0.43 | −3.10 | 66.04 | −4.01 | 17.94 | 64.14 | −10.28 | 6.45 | 26.4 | 66.0 | 44.7 | 0.020 | 0.84 |
| (3.2 | | | | | | | | | | | | | | |
| mm) | | | | | | | | | | | | | | |
| Ex. 15⁴ | 77.96 | −1.82 | −3.32 | 66.77 | −3.12 | 19.32 | 64.14 | −10.24 | 5.75 | 26.29 | 64.68 | 38.53 | 0.018 | no data |
| (6 mm) | | | | | | | | | | | | | | |
| NOTES: | | | | | | | | | | | | | | |
| ¹Emissivity is as measured using a Devices & Services bench-top emissometer; | | | | | | | | | | | | | | |
| ²The values listed for total solar energy transmitted (TSET), total solar energy reflected from the sample's coated surface (TSER1), and total solar energy reflected from the sample's uncoated (glass) surface (TSER2) are as-measured using a relative measurement procedure in which the transmitted or reflected amount of simulated solar illumination for the sample of interest is compared to a calibrated standard whose TSET | | | | | | | | | | | | | | |
| # and TSER properties have been measured previously. All solar property, and emissivity data are as-measured using spectrophotometric equipment and quoted solar properties represent integration of spectrophotometric data over the wavelength range 275-2125 nm. | | | | | | | | | | | | | | |
| ³The monolithic clear glass substrate thus coated has nominal thickness of 3.2 mm. Three pieces of the coated glass, each with lateral dimensions of about 4 inches × 8 inches, are cut down from the large plate using standard glass cutting tools. The three samples are then placed on a heating iron with coated surface up and then heated in a box oven set at 1300° F. for about six minutes. After heat-treatment, | | | | | | | | | | | | | | |
| # the samples are removed from the furnace and allowed to cool to room temperature in ambient air. The monolithic glass thus coated and heat treated had properties as detailed in Table IIIB above. | | | | | | | | | | | | | | |

⁴The clear glass for the coated glass of this example 15 had a thickness of 6 millimeter (0.236 inch) with the color and resistance for the sheet of glass shown in Table IIIB
⁵In Table IIIB, transmitted color data are as-measured using a TCS colorimeter (Illuminant D65, 10 degree observer) in the L, a*, b* (“CIELAB”) color system. Reflected color data are as-measured using a Hunter Miniscan colorimeter (Illuminant D65, 10 degree observer) in the same color system.
⁶Rₛₕₑₑₜ is the electrical sheet resistance of the sample's coated surface as measured with a four-point probe.

From Table IIIB the comparison of the color data for examples 14 and 15 for the 3.2 mm samples indicates the heat treated glass of example 15 is an approximate aesthetic and solar-performance “temperable match” to the sample of example.

The results of mechanical and chemical durability test conducted on the samples of coated glass or the examples 1-13 of Table I are shown in Table IV.

TABLE IV

| Sample | Initial | Salt | Ammonium | Acetic | DART | | Taber |
|---|---|---|---|---|---|---|---|
| No. | Haze | Test | Test | Acid | 210 | CCC | Test |
| 1 | ND | ND | ND | ND | ND | ND | ND |
| 2 | ND | ND | ND | ND | ND | ND | ND |
| 3 | ND | ND | ND | ND | ND | ND | ND |
| 4 | ND | ND | ND | ND | ND | ND | ND |
| 5 | 12.0 | 9.0 | 10.0 | 9.0 | 9.5 | 8.5 | 65 |
| 6 | 11.0 | 8.5 | 9.0 | 8.5 | 9.0 | 7.0 | ND |
| 7 | 11.0 | 9.0 | 9.5 | 9.5 | 9.0 | 9.0 | 62 |
| 8 | 11.0 | 9.0 | 9.0 | 9.5 | 9.0 | 8.5 | ND |
| 9 | 11.0 | 9.0 | 9.0 | 9.5 | 8.5 | 9.0 | 63 |
| 10 | 11.0 | 8.5 | 9.0 | 8.0 | 8.5 | 6.0 | ND |
| 11 | 9.0 | 9.0 | 9.0 | 9.5 | 9.0 | 9.0 | 58 |
| 12 | 9.5 | 9.0 | 9.0 | 9.0 | 9.5 | 9.0 | 56 |
| 13 | 9.3 | 9.0 | 9.3 | 9.5 | 9.0 | 9.3 | 63 |

The haze ratings shown in Table IV are based on a twelve unit system, with twelve being substantially haze free and lower numbers indicating increasing levels of haze. In the following discussion unless indicated to the contrary, the observation for haze was performed as follows. A coated piece glass (“coupon”) was treated in accordance with the particular test being conducted. The coupons were individually observed with the unaided eye in a dark room with about 150 watt flood light. The coupon was placed in front of the light, and its position was adjusted relative to the light to maximize haze. The observed haze was then rated.

The salt water test consists of placing the coated glass pieces or coupons in a 2.5 weight percent (wt %) solution of sodium chloride in deionized water for 2.5 hours. The coupons were removed, rinsed in deionized water and dried with pressurized nitrogen and then rated for haze.

In the ammonium hydroxide test a test coupon was placed in a 1 Normal solution of ammonium hydroxide in deionized water at room temperature for 10 minutes. The coupon was removed from the solution, rinsed in deionized water and dried as discussed above. The test coupon was examined for haze.

In the acetic acid test a test coupon was submerged in a 1 normal solution of acetic acid in deionized water at room temperature for 10 minutes. The test coupon was removed from the solution and rinsed off with deionized water and blown dry using high pressure nitrogen. The test coupon was examined for haze.

The Cleveland Condensation Chamber (CCC) test is a well-known test and is not discussed in detail herein. The test coupons were exposed to the CCC test for a period of time with warm water vapor and examined for haze. The abbreviation “ND” stands for “no data”.

The Taber test is also a well known test and will not be described in detail. Generally the modified Taber test comprises securing the sample to be tested on a flat, circular turntable. Two circular, rotating Calibrase® CS-10F abrasive wheels (commercially available from Taber Industries of N. Tonawanda, N.Y.) are lowered onto the top surface of the sample to be tested; there is a load of 500 grams applied to each abrasive wheel. The Calibrase® CS-10F wheels are an elastomeric-type material that is impregnated with an abrasive. To conduct the test, the turntable is switched “ON” and the abrasive wheels turn and abrade the sample's surface as the sample and turntable rotate about a vertical axis until the desired number of rotations or “cycles”, here 10, is completed. After testing, the sample is removed from the turntable and examined for damage to the top surface. The numbers in Table IV denote the scratch density per square millimeter for a black and white micrograph at a 50×magnification.

Thus, the present invention provides coated glass for a low emissivity, solar control article, especially for use in an IG unit. The coated glass provides a double-glazed IG unit that has a visible light transmission of less than 70 percent suitably a value in the range of 1 to 70 preferably from greater than about 40% to 70%; a shading coefficient less than about 0.44 and a solar heat gain coefficient of less than about 0.38 and a ratio of luminous transmittance to solar heat gain coefficient of greater than about 1.85 and an attractive, or at least acceptable, transmitted and exterior reflected color/aesthetic. The “double-glazed” IG unit is one comprising one outboard light of clear float glass having nominal thickness of 6 mm with said optical stack of the coating for the present invention on the inboard surface of the outboard glass light. The IG-unit also has one inboard light of clear float glass having nominal thickness of 6 mm, and an airspace with nominal width of 0.5 inch, and a nominal gas fill of air or argon.

In the preferred embodiment of the present invention for commercial applications of coated glass for IG units the coated glass has the optical stack of coating layers of:

The first (“basecoat”) dielectric layer as disclosed above comprising one or more dielectric films having refractive index (“n” ) of greater than or about equal to 1.8 (i.e. n> or equal to 1.8), more preferably greater than or about equal to 2 (i.e. n> or=to 2), in the visible portion of the electromagnetic spectrum; and

I. The optional first “sub-primer” layer as disclosed above; and

II. The first infrared-reflective layer comprising one or more infrared-reflective metals or metal alloys, preferably silver or alloys of silver with other metals having thickness of less than or equal to about 250 Å (corresponds to an areal silver density of about 26.3 μg/cm²), more preferably about 50-170 Å (corresponds to an areal silver density of about 5.0-17.6 μg/cm²), still more preferably about 70-155 Å (corresponds to an areal silver density of about 7.3-16.3 μg/cm²), even more preferably about 80-145 Å (corresponds to an areal silver density of about 8.4-15.2 μg/cm²), yet even more preferably about 90-133 Å (corresponds to an areal silver density of about 9.4-14.0 μg/cm²), and most preferably about 100-125 Å (corresponds to an a real silver density of about 10.5-13.1 μg/cm²); and

III. The first “barrier” or “primer” layer having been deposited as one or more films of metals or metal alloys, preferably titanium or alloys of titanium with other metals; and

IV. The second (“centercoat”) dielectric layer comprising one or more dielectric films having refractive index of greater than or about equal to 1.8 (i.e. n> or=to 1.8), more preferably greater than or about equal to 2 (i.e. n> or=to 2), in the visible portion of the electromagnetic spectrum; and

V. The optional second “sub-primer” layer as disclosed above; and

VI. The second infrared-reflective layer comprising one or more infrared-reflective metals or metal alloys, preferably silver or alloys of silver with other metals having thickness of less than or equal to about 340 Å (corresponds to an areal silver density of about 35.7 μg/cm²), more preferably about 110-340 Å (corresponds to an areal silver density of about 11.5-35.7 μg/cm²), even more preferably about 130-310 Å (corresponds to an areal silver density of about 13.7-32.5 μg/cm²), still more preferably about 160-290 Å (corresponds to an areal silver density of about 16.8-30.4 μg/cm²), even still more preferably about 180-270 Å (corresponds to an a real silver density of about 18.9-28.3 μg/cm²), yet even still more preferably about 200-250 Å (corresponds to an areal silver density of about 21.0-26.2 μg/cm²), and most preferably about 225 Å (corresponds to an areal silver density of about 25.1 μg/cm²); and

VII. The optional second “barrier” or “primer” layer having been deposited as one or more films of metals or metal alloys, preferably titanium or alloys of titanium with other metals; and

VIII. The third (“topcoat”) dielectric layer comprising one or more dielectric films having refractive index of greater than or about equal to 1.8 (n>or=to 1.8), more preferably greater than or about equal to 2 (i.e. n> or =to 2) in the visible portion of the electromagnetic spectrum; and

IX. The optional “overcoat” dielectric layer as disclosed above; and

X. The optional Temporary Protective Overcoat layer as disclosed above.

This coated glass provides a double-glazed IG unit that has a visible light transmission of less than 70% suitably a value in the range of 1 to 70 preferably from greater than about 40 to 70%; a shading coefficient less than about 0.44 and a solar heat gain coefficient of less than about 0.38 and a ratio of luminous transmittance to solar heat gain coefficient of greater than about 0.85 preferably greater than 1.9 and an attractive, or at least acceptable, transmitted and exterior reflected color/aesthetic. The “double-glazed” IG unit is one comprising one outboard light of clear float glass having nominal thickness of 6 mm with said optical stack of the coating for the present invention on the inboard surface of the outboard glass light. The IG-unit also has one inboard light of clear float glass having nominal thickness of 6 mm, and an airspace with nominal width of 0.5 inch, and a nominal gas fill of air or argon.

In an alternative embodiment, a solar control coated article of the invention comprises a substrate with a first antireflective layer deposited over at least a portion of the substrate. A first infrared reflective film is deposited over the first antireflective layer and a first primer film is deposited over the first infrared reflective film. A second antireflective layer is deposited over the first primer film and a second infrared reflective film is deposited over the second antireflective layer. A second primer film is deposited over the second infrared reflective film and a third antireflective layer is deposited over the second primer film, such that the coated article provides for a transmittance greater than about 55%, a shading coefficient of less than about 0.33 and a reflectance of less than about 30% in an IG unit. A protective overcoat, e.g. an oxide or oxynitride of titanium or silicon, may be deposited over the third antireflective film. For residential applications of the coated glass provides IG units where the glass thickness may be 3.2 mm (0.126 inch) with values of the shading coefficient preferably can be less than 0.33 and the exterior reflectance can be less than about 30%. Such an article for residential application is particularly well adapted for use in warmer climates to help reduce cooling costs for the interior of a structure.

It will be readily appreciated by those skilled in the art that modifications may be made to the invention without departing from the concepts disclosed in the foregoing description. Such modifications are to be considered as included within the scope of the invention. Accordingly, the particular embodiments described in detail hereinabove are illustrative only and are not limiting as to the scope of the invention, which is to be given the full breadth of the above disclosure and any and all equivalents thereof.

What is claimed is:

1. A solar control article, comprising:
a substrate having a surface;
at least one antireflective layer deposited over the substrate surface; and
at least one infrared reflective film deposited over the at least one antireflective layer,
such that the coated article has a luminous transmission of less than about 70 percent, a shading coefficient less than about 0.44 and a solar heat gain coefficient of less than about 0.38 and a ratio of luminous transmittance to solar heat gain coefficient of greater than about 1.85.

2. The article as claimed in claim 1, wherein the luminous transmission is greater than about 40%, the shading coefficient less than about 0.33 and the article has a visible reflectance less than about 30%

3. The article as claimed in claim 1, wherein the antireflective layer comprises at least one film selected from one or more metal oxides, oxides of metal alloys, doped metal oxides, nitrides, oxynitrides, and mixtures thereof.

4. The article as claimed in claim 1, wherein the one or more films are selected from zinc oxide, titanium oxide, hafnium oxide, zirconium oxide, niobium oxide, bismuth oxide, indium oxide, tin oxide, silicon nitride, silicon oxynitride and mixtures thereof.

5. The article as claimed in claim 1, wherein the metal alloys are selected from the group consisting of zinc-tin, tin alloys, fluorine doped tin, antimony doped tin, and indium-tin alloys.

6. The articles as claimed in claim 3, wherein the infrared reflective films include at least one metal selected from the group consisting of gold, copper, platinum, and silver and mixtures thereof.

7. The article as claimed in claim 1, wherein the article includes a first antireflective layer, a second antireflective layer, a third antireflective layer, a first infrared reflective layer and a second infrared reflective layer, with the first infrared reflective layer deposited over the first antireflective layer and the second infrared reflective layer deposited over the second antireflective layer and with the third antireflective layer deposited over the second infrared reflective layer.

8. The article as claimed in claim 7, including a first primer layer deposited over the first infrared reflective layer and an optional second primer layer deposited over the second infrared reflective layer.

9. The article as claimed in claim 7, wherein the antireflective layers include films selected from one or more metal oxides, oxides of metal alloys, doped metal oxides, nitrides and oxynitrides and mixtures thereof.

10. The article as claimed in claim 9, wherein the one or more films are selected from zinc oxide, titanium oxide, hafnium oxide, zirconium oxide, niobium oxide, bismuth oxide, indium oxide, tin oxide, silicon nitride, silicon oxynitride and mixtures thereof.

11. The article as claimed in claim 7, wherein the metal alloys are selected from the group consisting of zinc-tin, tin alloys, fluorine doped tin, antimony doped tin, and indium-tin alloys.

12. The article as claimed in claim 7, wherein at least one of the antireflective layers comprises a plurality of antireflective films.

13. The articles as claimed in claim 7, wherein the infrared reflective films include at least one metal selected from the group consisting of gold, copper, platinum, and silver and mixtures thereof.

14. The article as claimed in claim 7, wherein the first antireflective layer has an optical thickness of less than about 900 Å, the second antireflective layer has an optical thickness generally less than about 2600 Å, and the third antireflective layer has an optical thickness of less than about 800 Å.

15. The article as claimed in claim 7, wherein the first antireflective layer has an optical thickness in the range of about 350 to about 830 Å, the second antireflective layer has an optical thickness in the range of about 1000 to about 2450 Å, and the third antireflective layer has an optical thickness in the range of 180 to 780 Å.

16. The article as claimed in claim 7, wherein the first antireflective layer has an optical thickness in the range of about 530 to about 650 Å, the second antireflective layer has an optical thickness in the range of about 1500 to about 1900 Å, and the third antireflective layer has an optical thickness in the range of about 210 to about 730 Å.

17. The article as claimed in claim 7, wherein the first antireflective layer has a physical thickness of about 272 to about 332 angstroms, the second antireflective layer has a physical thickness of about 198 to about 836 angstroms and the third antireflective layer has a physical thickness of about 60 to about 273 angstroms.

18. The article as claimed in claim 3, wherein the first infrared reflective layer has a physical thickness of less than about 270 angstroms and the second infrared reflective layer has a physical thickness of less than 340 angstroms.

19. The article as claimed in claim 18, wherein the first infrared reflective layer has a thickness of about 86 to about 269 angstroms and the second infrared reflective layer has a thickness of about 159 to about 257 angstroms.

20. The article as claimed in claim 3, wherein the ratio of the physical thickness of the second silver-containing infrared-reflective layer to the first silver-containing infrared-reflective layer is in the range of about 1.5 to about 3.5.

21. The article as claimed in claim 1, which includes at least one sub-primer layer in proximity to the IR reflective layer where the sub-primer layer is less than about 100 Å.

22. The article as claimed in claim 21, wherein the sub-primer layer is comprised of at least one transition metal and alloys thereof.

23. The article as claimed in claim 22, wherein the transition metal is selected from copper, titanium, nickel, Inconnel, stainless steel, tungsten, and alloys and mixtures of one or more of these.

24. The article as claimed in claim 3, wherein the first and second primer layers each have a physical thickness of about 15 to about 30 angstroms.

25. The article as claimed in claim 3, wherein the thickness of the second infrared reflective layer is about 50 to about 100% greater than the thickness of the first infrared reflective layer.

26. The article as claimed in claim 7, including a protective overcoat deposited over the third antireflective layer.

27. The article as claimed in claim 1, wherein the substrate is selected from the group consisting of non-metals, glass, plastic and ceramic.

28. The article as claimed in claim 1, wherein the article is an insulated glass unit.

29. A solar control coated article, comprising:
a substrate having a surface;
a first antireflective layer deposited over a substrate surface;
a first infrared reflective layer deposited over the first antireflective layer;
a first primer layer deposited over the first infrared reflective layer;
a second antireflective layer deposited over the first primer layer;
a second infrared reflective layer deposited over the second antireflective layer;
a second primer film deposited over the second infrared reflective layer; and
a third antireflective layer deposited over the second primer layer, such that the coated article gives a luminous transmission of less than 70%, a solar heat gain coefficient of less than about 0.38 and a ratio of luminous transmittance to solar heat gain coefficient of greater than about 1.85.

30. The article as claimed in claim 29, wherein the article has a substantially neutral color.

31. The article as claimed in claim 29, wherein the article has a transmittance greater than about 55%, a shading coefficient of less than about 0.33 and an external reflectance less than about 30%.

32. The article as claimed in claim 31, wherein the article has a transmittance greater than about 55%, a shading coefficient of less than about 0.32 and an external reflectance less than about 20%.

33. The article as claimed in claim 29, wherein the substrate is selected from the group consisting of glass, plastic and ceramic.

34. The article as claimed in claim 29, wherein the antireflective films include a film selected from the group consisting of metal oxides, metal alloys, doped metal oxides, nitrides, oxynitrides and mixtures thereof.

35. The article as claimed in claim 34, wherein in the films are selected from the group consisting of zinc oxide, titanium oxide, hafnium oxide, zirconium oxide, niobium oxide, bismuth oxide, indium oxide, tin oxide, silicon nitride, silicon oxynitride and mixtures thereof.

36. The article as claimed in claim 34, wherein the metal alloys are selected from the group consisting of zinc stannate, fluorine doped tin, antimony doped tin, and indium-tin alloys.

37. The article as claimed in claim 34, wherein the doped metal oxides are selected from the group consisting of antimony doped tin oxide and indium doped tin oxide.

38. The article as claimed in claim 29, wherein the first infrared reflective layer includes a metal from the group consisting of gold, copper, platinum, and silver and mixtures thereof.

39. The article as claimed in claim 29, where at least one of the first, second, or third antireflective layers includes a plurality of antireflective films.

40. The article as claimed in claim 29, wherein the primer layer includes titanium.

41. The article as claimed in claim 29, including a protective, metal containing overcoat deposited over the third antireflective layer.

42. The article as claimed in claim 29, which includes at least one sub-primer layer in proximity to the IR reflective layer where the sub-primer layer is less than about 100 Å, comprised of at least one transition metal and alloys thereof.

43. The article as claimed in claim 42, wherein the transition metal is selected from copper, titanium, nickel, Inconnel, stainless steel, tungsten, and alloys and mixtures of one or more of these.

44. The article as claimed in claim 29, wherein the article is an insulated glass unit.

45. The article as claimed in claim 29, wherein the first antireflective layer has a physical thickness of about 272 to about 332 angstroms, the second antireflective layer has a physical thickness of about 198 to about 836 angstroms and the third antireflective layer has a physical thickness of about 60 to about 273 angstroms.

46. The article as claimed in claim 29, wherein the first infrared reflective layer has a thickness of about 86 to about 269 angstroms and the second infrared reflective layer has a thickness of about 159 to about 257 angstroms.

47. The article as claimed in claim 29, wherein the first and second primer layers each have a thickness of about 15 to about 30 angstroms.

48. The article as claimed in claim 29, wherein the first antireflective layer has an optical thickness in the range of about 530 to about 650 Å, the second antireflective layer has an optical thickness in the range of about 1500 to about 1900 Å, and the third antireflective layer has an optical thickness in the range of about 210 to about 730 Å.

49. The article as claimed in claim 7, which includes an outer layer of at least one removable protective films, layers or coatings selected from solvent soluble organic coatings, water-soluble or water-dispersible film-forming polymeric, material.

50. The article as claimed in claim 29, which includes an outer layer of at least one removable protective films, layers or coatings selected from solvent soluble organic coatings, water-soluble or water-dispersible film-forming polymeric, material.

51. A method of making a solar control article, comprising the steps of:
providing a substrate having a surface;
depositing at least one antireflective layer over the substrate surface; and
depositing at least one infrared reflective layer over the at least one antireflective layer such that the coated article has a luminous transmittance of less than about 70% greater than about 55%, a shading coefficient less than about 0.44, a solar heat gain coefficient of less than about 0.38 and a ratio of luminous transmittance to solar heat gain coefficient of greater than about 1.85.

52. The method as claimed in claim 51, including depositing a first infrared reflective film over a first antireflective layer, depositing a second infrared reflective film over a second antireflective layer and depositing a third antireflective layer over the second infrared reflective film.

53. The method as claimed in claim 51, including depositing a first primer film over the first infrared reflective film and depositing a second primer film over the second infrared reflective film.

54. The method as claimed in claim 51, wherein the article has a substantially neutral color.

55. The article as claimed in claim 51, wherein the antireflective layer depositing step is practiced by depositing a plurality of antireflective films to form the at least one antireflective layer.

56. The method as claimed in claim 51, wherein the first infrared reflective film has a thickness of about 86 to about 269 angstroms and the second infrared reflective film has a thickness of about 159 to about 257 angstroms.

57. The method as claimed in claim 32, wherein the first and second primer films each have a thickness of about 15 to about 20 angstroms.
